(19) United States
(12) Patent Application Publication
(10) Pub. No.: US 2025/0146629 A1
(43) Pub. Date: May 8, 2025

(54) Optical System For Dynamic Color Transformation Using Single-Color LED Animation And Dichroic Film Configuration

(71) Applicants: Wenjie Zhan, Waltham, MA (US); Yingqiu Huang, Waltham, MA (US)

(72) Inventors: Wenjie Zhan, Waltham, MA (US); Yingqiu Huang, Shanghai (CN)

(21) Appl. No.: 18/942,379

(22) Filed: Nov. 8, 2024

(30) Foreign Application Priority Data
Nov. 8, 2023 (CN) CN221648254U

(51) Int. Cl. F21K 9/64; F21K 9/238; F21K 9/90; F21Y 103/33; F21Y 115/10; H05B 47/165

(52) U.S. Cl. CPC F21K 9/64; F21K 9/238; F21K 9/90; H05B 47/165; F21Y 2103/33; F21Y 2115/10

(57) ABSTRACT

The utility model relates to the field of LED illumination, in particular to a multicolor LED atmosphere lamp. Which mainly comprises a housing comprising a base plate and a light-transmitting lamp shade connected with the base plate, and an LED assembly mounted on the base plate, characterized in that, the LED assembly comprises a plurality of LED lamp beads and a control device for controlling the working states of the plurality of LED lamp beads, the atmosphere lamp further comprises a color light-transmitting plate arranged on the substrate, and the color light-transmitting plate is used for reflecting and transmitting light rays emitted by the LED lamp beads. The LED atmosphere lamp is only provided with basic single-color LED lamp beads, so that the cost is greatly reduced; and the light effect with more complexity and layering can be realized by matching with a special light transmission structure, and even the light dynamic effect of a specific theme can be simulated, so that the ornamental value is greatly improved.

### CROSS-REFERENCE TO RELATED APPLICATIONS

This application claims priority to Chinese Utility Model Patent No. CN221648254U, issued on Sep. 3, 2024, filed on Nov. 8, 2023, the entire contents of which are hereby incorporated by reference herein in their entirety.

### BACKGROUND OF THE INVENTION

With the continuous development of lighting technology and increasing aesthetic requirements, LED lighting has expanded beyond traditional illumination into decorative and atmospheric applications. These developments have led to various approaches for creating dynamic and colorful lighting effects.

Several prior art solutions have attempted to achieve color-changing effects through different methods. For example, U.S. Pat. No. 6,016,038 to Mueller describes a multicolored LED lighting method using pulse width modulated current control with multiple colored LEDs. Similarly, U.S. Pat. No. 7, 119,501 and U.S. Patent Application Publication No. 2002/0071279 disclose systems utilizing multiple colored LEDs to produce various color combinations.

Other approaches, as shown in U.S. Pat. No. 6,572,241, have focused on creating color washing effects using programmed, animated multi-color LED arrays. U.S. Patent Application Publications 2007/0183152 and 2013/0113394 demonstrate methods for achieving moving light effects through programmed LED control systems.

The use of dichroic films in lighting applications has been explored, as evidenced by U.S. Patent Application Publication No. 2005/0079333, which describes the application of color-shifting films in lighting fixtures to produce varying appearances based on viewing angles. U.S. Patent Application Publication No. 2013/0051028 further shows the combination of LEDs with dichroic films in static applications.

Additionally, various patents such as U.S. Patent No. 11, 187,391 and U.S. Patent Application Publications 2003/0058191 and 2010/0007590 demonstrate methods for creating distinctive color patterns using complex grid arrangements of multiple LEDs.

However, these prior art solutions have several limitations. Systems using multiple colored LEDs are typically more expensive and complex to implement. Color-mixing approaches using multiple LED arrays often result in visible gaps or discontinuities in the color transitions. Static applications of dichroic films fail to fully utilize their color-shifting potential in dynamic lighting scenarios.

Furthermore, existing solutions for creating distinctive color patterns typically rely on complex arrangements of multiple-colored LEDs, resulting in higher costs and more complicated control systems. The prior art has not adequately addressed the challenge of creating smooth, dynamic color transitions and distinct pattern formations using simplified LED configurations.

There remains a need for a lighting system that can achieve dynamic color transformations and distinctive pattern effects using a simplified LED configuration while maintaining smooth color transitions and reducing system complexity and cost.

### SUMMARY OF THE INVENTION

The present invention provides an optical system that creates dynamic color transformation effects using a unique combination of animated single-color LED lighting and dichroic film configuration. The system achieves complex color morphing effects without the need for multiple colored LEDs, significantly reducing costs while enhancing visual appeal.

In one aspect, the invention comprises a housing with a base plate and light-transmitting shade, wherein a single-color LED assembly is mounted in a circular configuration on the base plate. The LED assembly includes programmable animation control that creates moving light patterns, which interact with strategically positioned dichroic films to produce dynamic color effects.

A key innovative feature of the invention is the creation of a distinct optical dividing line, formed where the dichroic film assembly contacts the inner surface of the light-transmitting shade. This optical dividing line serves as a dynamic color boundary, where the dichroic film assembly extends to meet the inner surface of the shade at various possible angles, creating distinct color zones. The interaction between the animated single-color LED patterns and the strategically positioned dichroic film assembly creates smooth color transitions across this optical boundary. The invention achieves several advantages over prior art:
Creates complex color effects using only single-color LEDs
Produces smooth color morphing without visible color mixing
Generates distinctive visual patterns through optical division
Achieves dynamic color transformation through position-dependent light animation
Creates distinct optical boundaries without additional components

The system's unique configuration allows for:
Programmable light animation sequences
Position-dependent color transformation
Smooth transitional effects between colors
Creation of distinct visual zones through optical division
Enhanced aesthetic appeal through natural color morphing

In various embodiments, the invention can be implemented in different housing configurations while maintaining the same core technical principles.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a perspective view of a lighting apparatus according to one embodiment of the present disclosure.

FIG. 2 is an exploded view of the lamp of FIG. 1

FIG. 3 is a cross-sectional view viewed along line 3-3 of FIG. 5.

FIG. 3 is a cross-sectional view taken along line 3-3 of FIG. 1, illustrating the positioning of the dichroic film assembly relative to the light-transmitting shade.

FIG. 4 is a top plan view of base 200 showing the arrangement of the programmable single-color LED array and other components on the base plate.

FIG. 5 is a top view of the lighting apparatus according to one embodiment of the present disclosure.

FIG. 6A-6D is a series of simplified top view of the LED array 260 and dichroic film assembly 280.

FIG. 7A-7D are sequential views of the lighting apparatus illustrating the dynamic color transformation effects created by the interaction between the moving illuminated LED group and the dichroic film assembly.

FIG. 7 is a detailed view showing the formation of the optical dividing line where the dichroic film assembly meets the inner surface of the light-transmitting shade.

FIG. 8 is a cross-sectional detail view showing the mounting configuration of the dichroic film assembly.

FIG. 9 is a flowchart of an illustrative process for creating an illumination system with dynamic color transformation effects and optical dividing lines in accordance with some embodiments of the invention.

### DETAILED DESCRIPTION

Reference will now be made in detail to embodiments of the invention, examples of which are illustrated in the accompanying drawings. While the invention will be described in conjunction with these embodiments, it will be understood that they are not intended to limit the invention to these embodiments.

### Basic Structure and Components

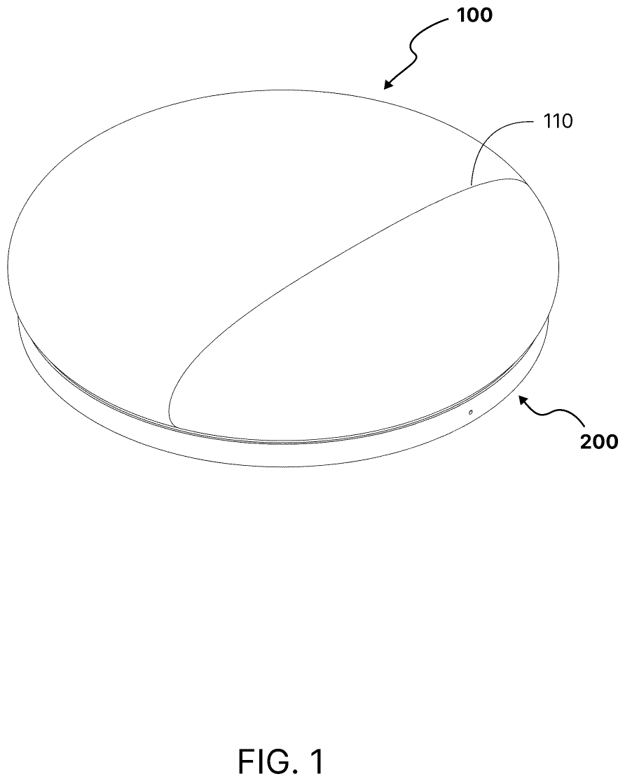

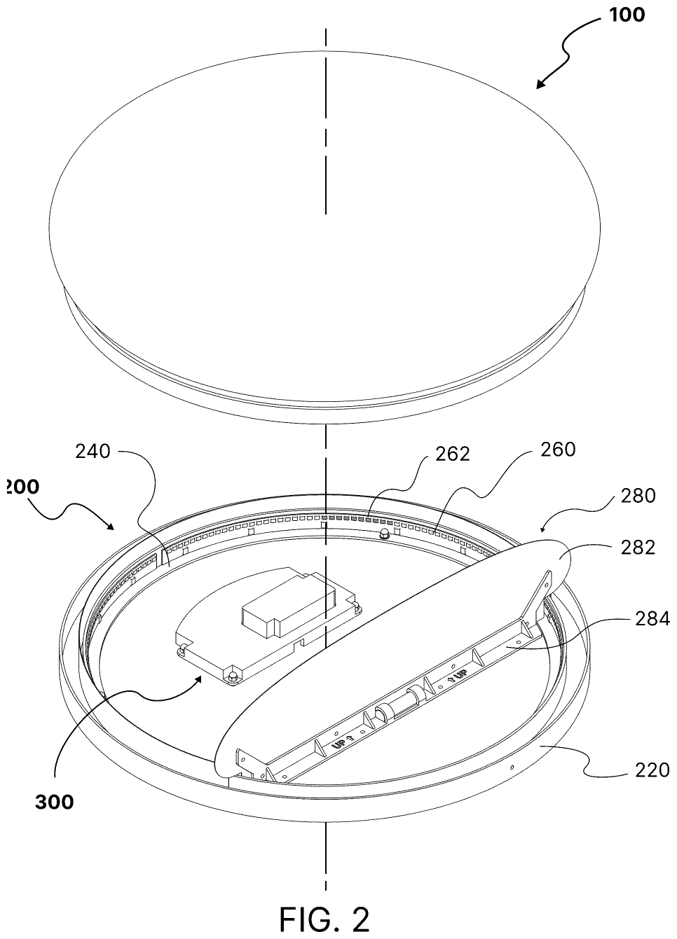

FIG. 1 is a perspective view of a lighting apparatus according to one embodiment of the present disclosure. FIG. 2 is an exploded view of the lamp of FIG. 1.

Referring to FIG. 2, an illumination system includes a housing assembly comprising a base 200 and a light-transmitting shade 100.

The base 200 is composed of a base plate 220 and a side plate 240 perpendicular to the base plate 220 and installed around the circumference of the base plate 220, which are fixedly connected together to increase the overall structural strength of the base plate 200 and provide stable support for the LED assembly 260 installed thereon.

The base 200 provides a mounting surface for various components of the system and may be configured in different shapes and sizes to accommodate various installation requirements.

The illumination system includes a programmable single-color LED array 260 mounted on the side base plate 240 in a predetermined configuration.

In the illustrated embodiment, the side plate 240 and LED array 260 is arranged in a circular pattern, though other configurations may be employed as will be described in detail below.

The LED array 260 comprises a plurality of individually addressable single-color LEDs, preferably white LEDs, capable of producing animated light patterns through programmed sequences.

A dichroic film assembly 280 is positioned to contact the inner surface of the light-transmitting shade 100. The dichroic film assembly 280 comprises base 284 that dichroic filter 282 attached too. The dichroic film assembly is fixed to the base plate 220. The dichroic filter 282 has a light-transmitting substrate, such as a transparent plastic sheet or acrylic panel, with a dichroic film applied thereto.

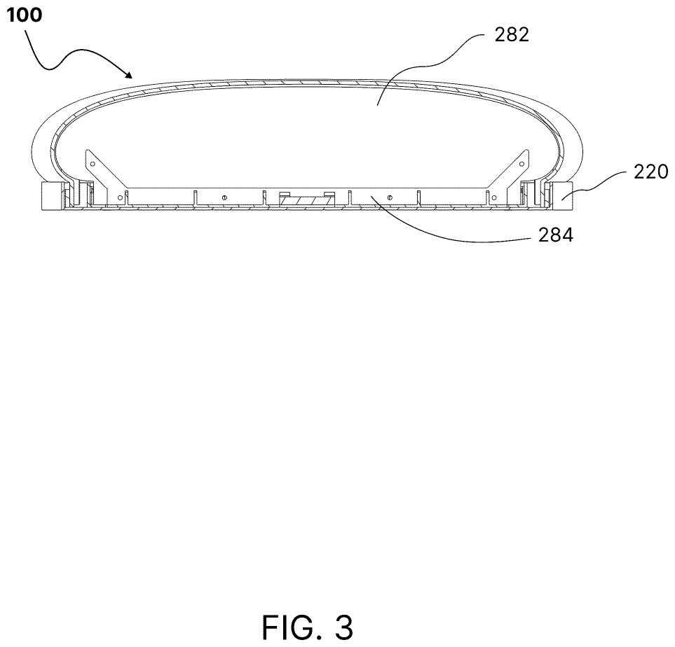

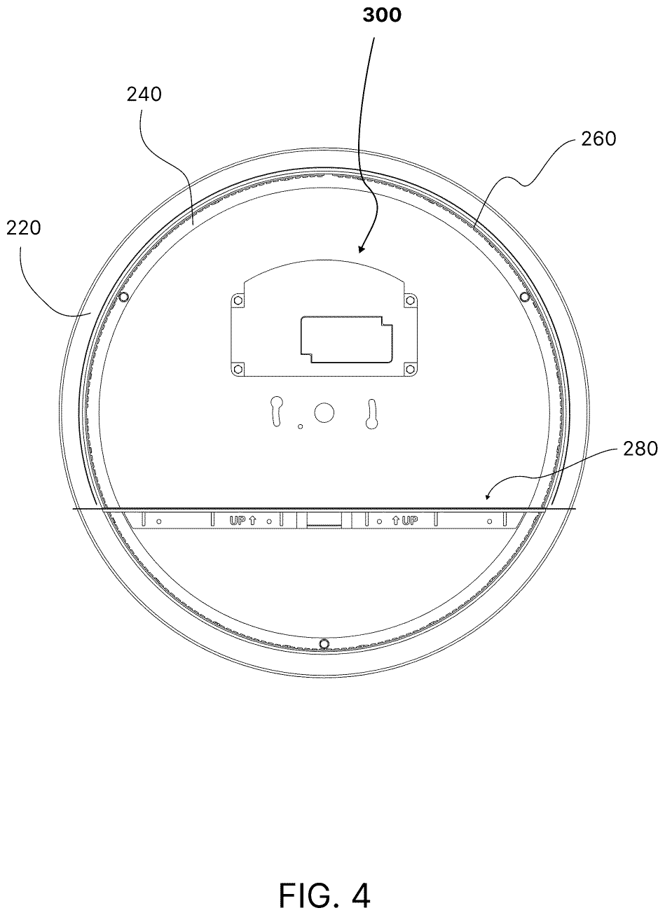

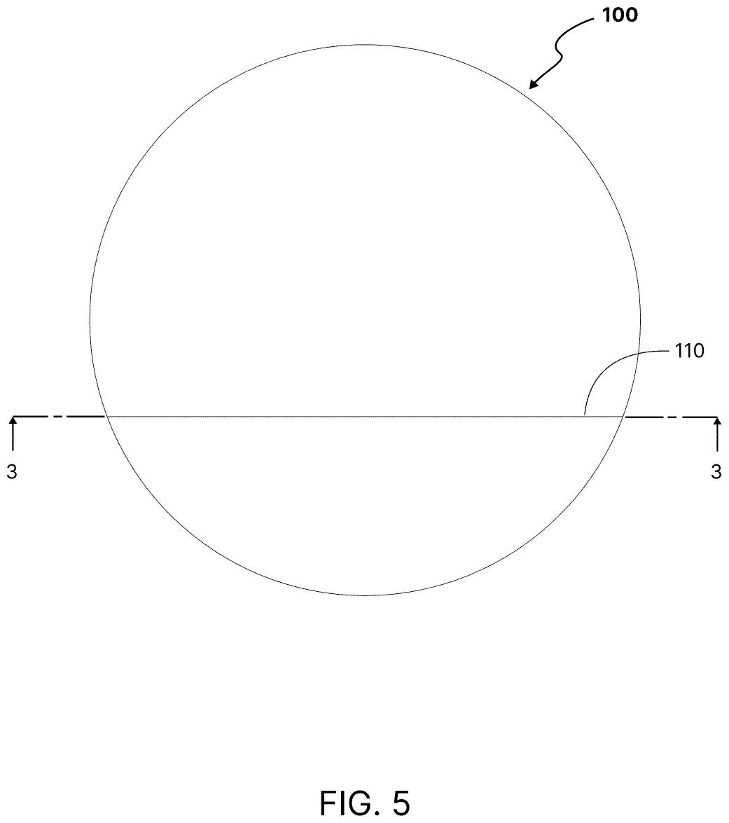

The dichroic film assembly 280 is configured to create an optical dividing line 110 by having the edge of the dichroic filter 282 positioned either in direct contact with, or in close proximity to (preferably within approximately 1 millimeter), the inner surface of the shade 100, as shown in FIG. 3 section view. This positioning of the dichroic filter edge relative to the shade's inner surface creates a distinct optical dividing line when viewed from the exterior of the shade.

This optical dividing line 110 serves as a color boundary that separates distinct color zones created by the interaction between the animated LED light patterns and the dichroic film.

The light-transmitting shade 100 is designed to diffuse and blend the light from the LED array 260 while maintaining optical clarity sufficient to preserve the color transformation effects created by the dichroic film assembly 280.

The shade 100 may be fabricated from various light-transmitting materials and can be formed in different shapes to achieve desired aesthetic effects while maintaining the functional aspects of the optical dividing line 110. A controller 300 is electrically connected to the LED array 260 to automate the animation of LED light movement.

The controller 300 includes programming capabilities to create various animation sequences that, when combined with the optical properties of the dichroic film assembly 280, produce dynamic color transformation effects visible through the light-transmitting shade 100.

### LED Animation and Color Transformation

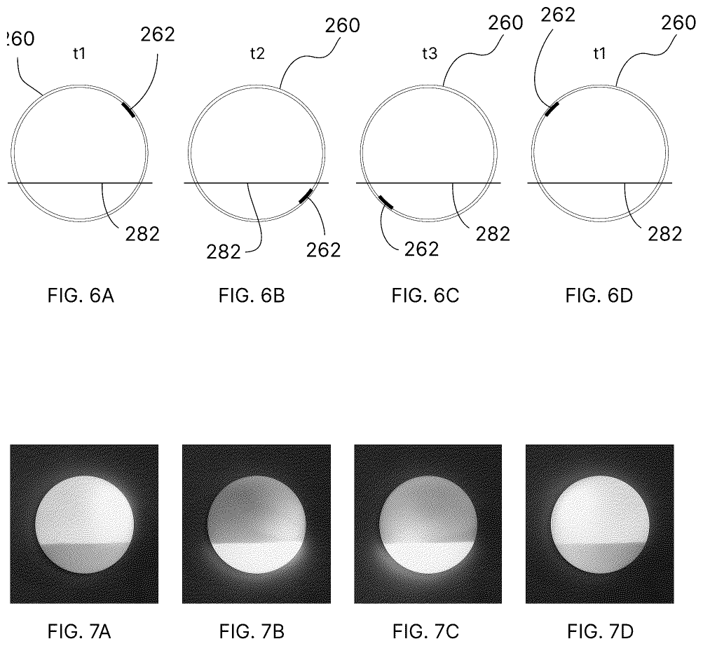

FIG. 6A-6D is a series of simplified top view of the LED array 260 and dichroic film assembly 280.

Referring to FIG. 2, the LED array 260 includes multiple individually addressable LEDs arranged in a predetermined configuration. During operation, an illuminated LED group 262 comprises a subset of LEDs that are activated at any given moment. This illuminated LED group 262 is not fixed to specific physical LEDs but rather represents a programmable sequence of LED activations that creates the appearance of light movement along the LED array path.

As illustrated in FIGS. 6A-6D, the illuminated LED group 262 can be programmed to move along the LED array 260 in various patterns and speeds. For example, in a basic animation sequence:
FIG. 6A shows the illuminated LED group 262 at a position at a time t1
FIG. 6B shows the illuminated LED group 262 at a position at a time t2
FIG. 6C shows the illuminated LED group 262 at a position at a time t3
FIG. 6D shows the illuminated LED group 262 at a position at a time t4

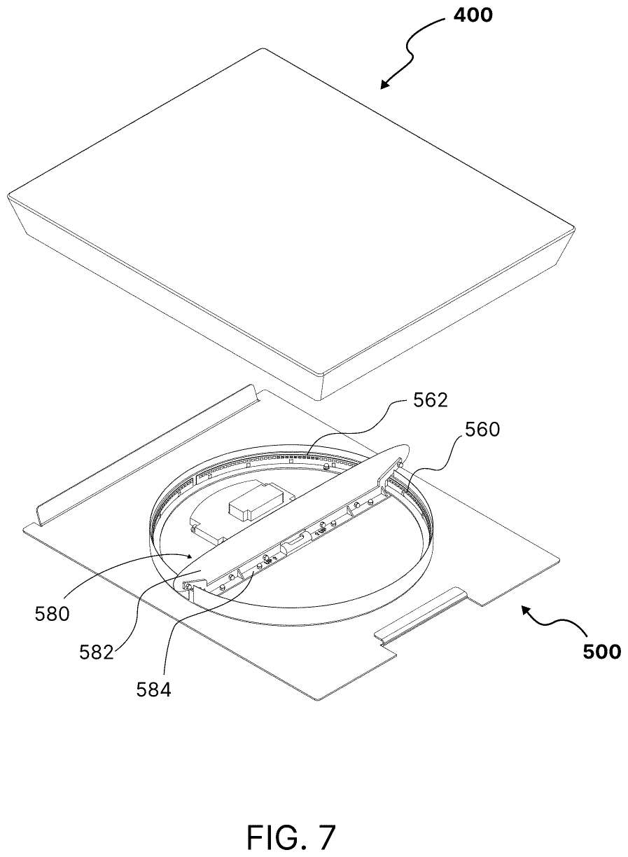

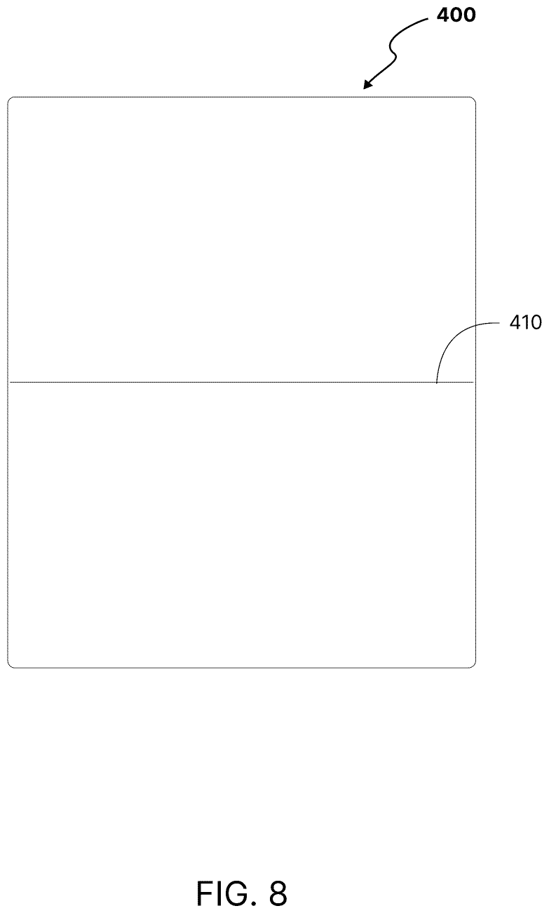

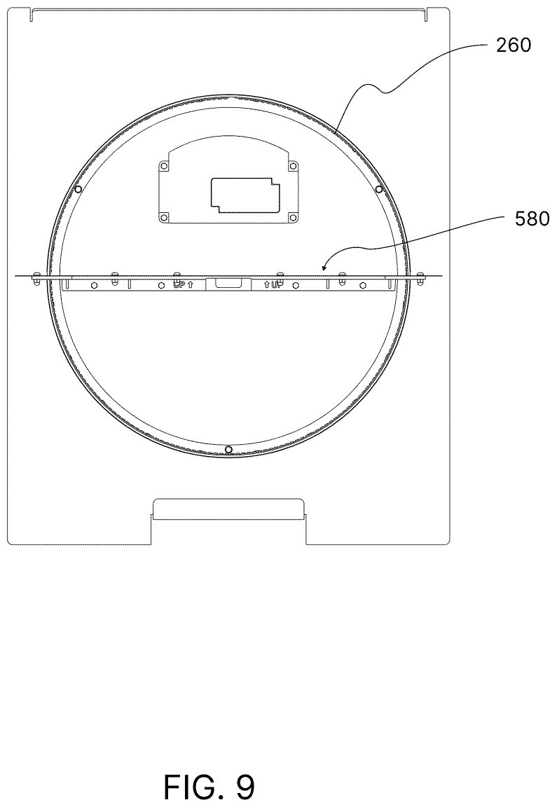

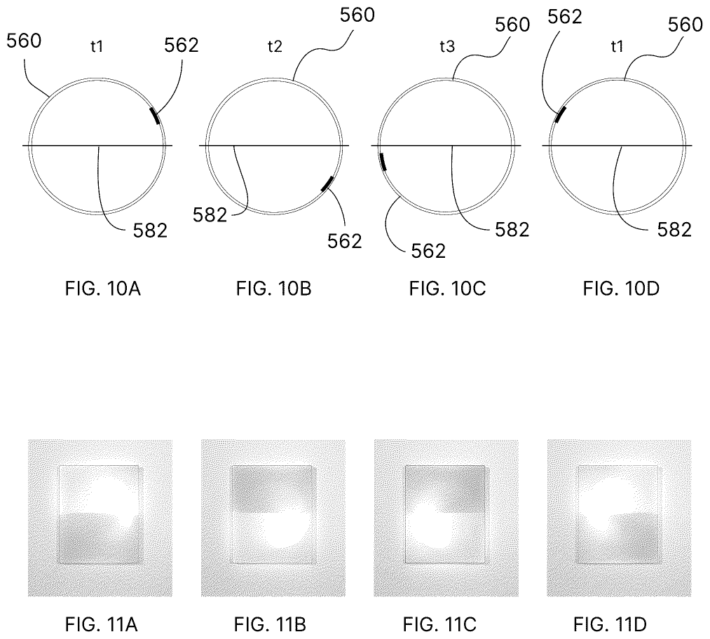

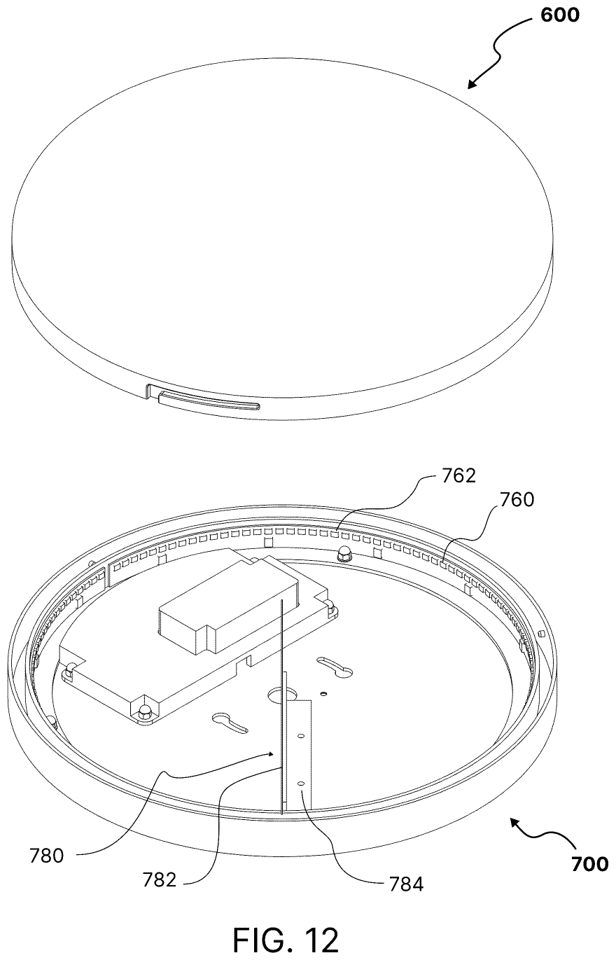

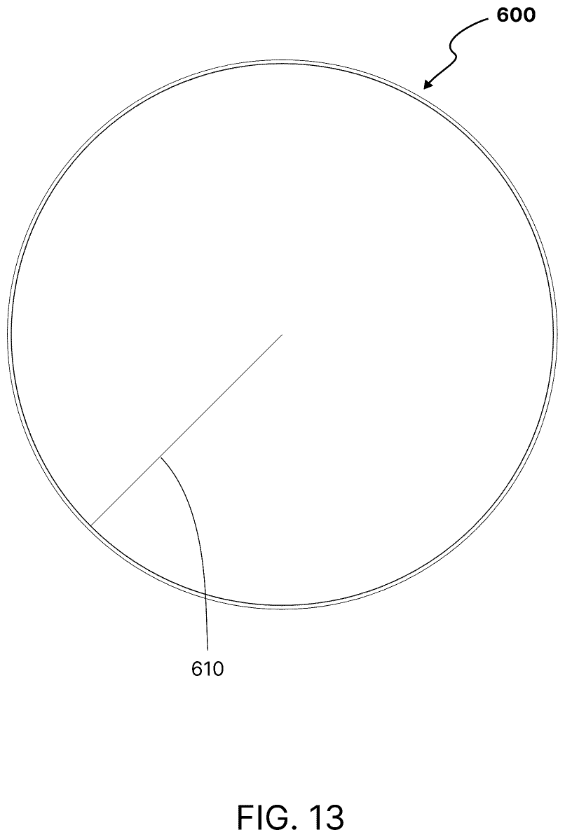

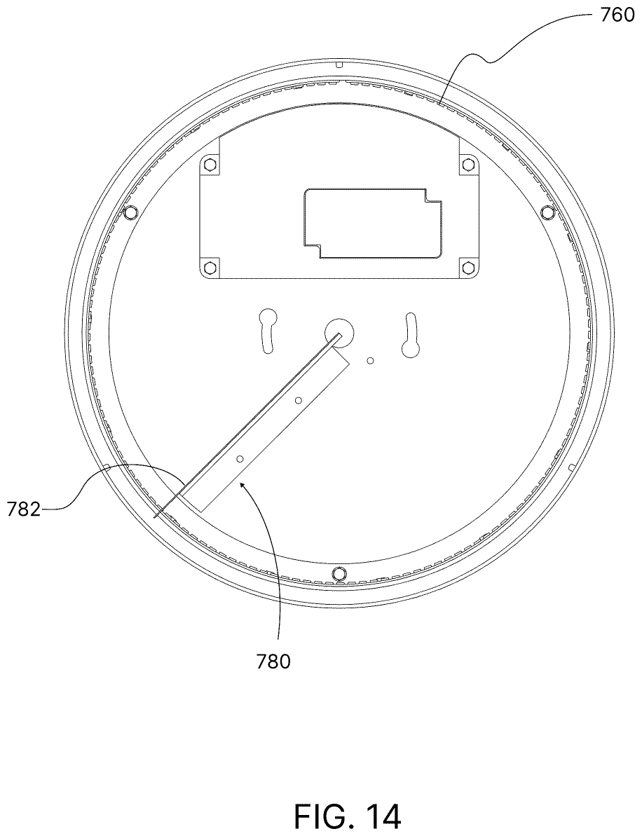

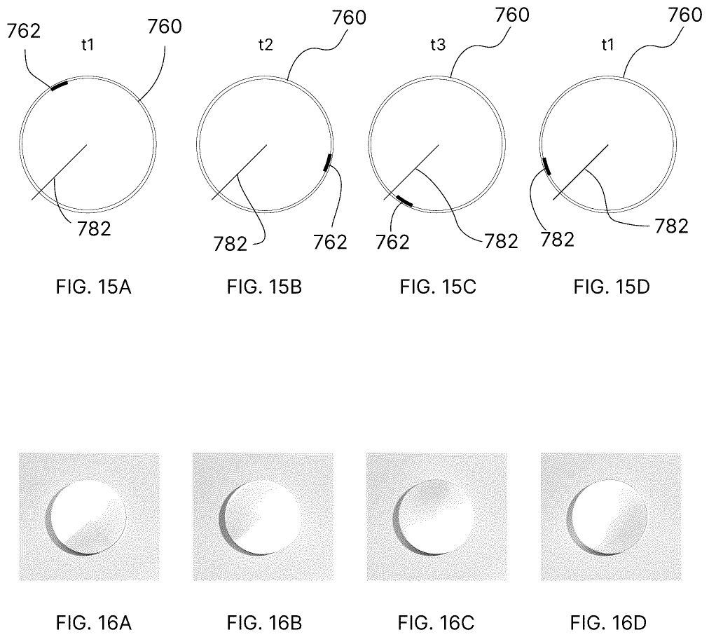

The interaction between the moving illuminated LED group 262 and the dichroic film assembly 280 creates dynamic color transformation effects through selective wavelength filtering and reflection. As illustrated in FIG. 7A-7D, this interaction produces two distinct color zones separated by the optical dividing line 110:

When the illuminated LED group 262 is positioned on one side of the dichroic film assembly 280:
The zone containing the illuminated LED group exhibits one set of colors due to direct light and reflections from the dichroic film
The opposite zone displays a complementary set of colors created by light passing through the dichroic film
The optical dividing line 110 creates a clear boundary between these color zones As the illuminated LED group 262 moves across the optical dividing line 110, the colors in both zones transition and swap, creating a dynamic color-flipping effect. Furthermore, the specific colors displayed in each zone continuously evolve based on:
The relative position of the illuminated LED group to the dichroic film
The angle at which light intersects the dichroic film
The interaction between transmitted and reflected light wavelengths

### Alternative Configurations and Methods

The illumination system described above can be implemented in various configurations while maintaining the same core principles of operation. These variations demonstrate the versatility of the invention in creating dynamic color effects through the interaction of programmable single-color LED animation and dichroic film assemblies.

### Base and Housing Configurations Example

Referring to FIG. 2, while the previously described embodiment shows a circular housing configuration, the illumination system can be implemented with a rectangular housing 400 while maintaining the circular LED array 560 configuration. This demonstrates that the LED array path configuration is independent of the housing shape, allowing for diverse aesthetic applications. Referring to FIG. 7, the LED array 560 includes multiple individually addressable LEDs arranged in a predetermined configuration. During operation, an illuminated LED group 562 comprises a subset of LEDs that are activated at any given moment. This illuminated LED group 562 is not fixed to specific physical LEDs but rather represents a programmable sequence of LED activations that creates the appearance of light movement along the LED array path.

As illustrated in FIGS. 10A-10D, the illuminated LED group 562 can be programmed to move along the LED array 560 in various patterns and speeds. For example, in a basic animation sequence:
FIG. 10A shows the illuminated LED group 562 at a position at a time t1
FIG. 10B shows the illuminated LED group 562 at a position at a time t2
FIG. 10C shows the illuminated LED group 562 at a position at a time t3
FIG. 10D shows the illuminated LED group 562 at a position at a time t4

The interaction between the moving illuminated LED group 562 and the dichroic film assembly 580 creates dynamic color transformation effects through selective wavelength filtering and reflection. As illustrated in FIG. 11A-11D, this interaction produces two distinct color zones separated by the optical dividing line 110, similar to yet distinct from what was illustrated in previous mentioned embodiment FIG. 6A-6D and FIG. 7A-7D

### Dichroic Film Assembly Configuration Alternative Example

As shown in FIG. 12, the dichroic film assembly 780 can be positioned from the center of the circular configuration of LED array 760, differing from previously mentioned dichroic film assembly 580 and 280. This demonstrates that the configuration of dichroic film assembly 280, 580, 780 is independent of the LED array shape 260, 560, 760, allowing for diverse aesthetic applications.

Referring to FIG. 12, the LED array 760 includes multiple individually addressable LEDs arranged in a predetermined configuration. During operation, an illuminated LED group 762 comprises a subset of LEDs that are activated at any given moment. This illuminated LED group 762 is not fixed to specific physical LEDs but rather represents a programmable sequence of LED activations that creates the appearance of light movement along the LED array path.

As illustrated in FIGS. 15A-15D, the illuminated LED group 762 can be programmed to move along the LED array 760 in various patterns and speeds. For example, in a basic animation sequence:
FIG. 15A shows the illuminated LED group 762 at a position at a time t1
FIG. 15B shows the illuminated LED group 762 at a position at a time t2
FIG. 15C shows the illuminated LED group 762 at a position at a time t3
FIG. 15D shows the illuminated LED group 762 at a position at a time t4

The interaction between the moving illuminated LED group 762 and the dichroic film assembly 780 creates dynamic color transformation effects through selective wavelength filtering and reflection. As illustrated in FIG. 16A-16D, this interaction produces two distinct color zones separated by the optical dividing line 110, similar to yet distinct from what was illustrated in previous mentioned embodiment FIG. 7A-7D and FIG. 11A-11D.

Each configuration creates distinct visual effects while maintaining the core principle of dynamic color transformation through the interaction between animated LED patterns and dichroic film assemblies.

1. An illumination system, comprising:
a housing including a base plate and a light-transmitting shade; a programmable single-color LED array mounted on the base plate in a predetermined configuration; a dichroic film assembly positioned relative to an inner surface of the light-transmitting shade to create an optical dividing line; and a controller configured to animate the LED array to create moving light patterns that interact with the dichroic film assembly to produce dynamic color transformation effects.

2. A method of creating dynamic color transformation effects, comprising:
mounting a programmable single-color LED array in a predetermined configuration on a base plate; positioning a dichroic film assembly relative to an inner surface of a light-transmitting shade to create an optical dividing line; programming an animation sequence for the LED array; and generating dynamic color transformation effects through interaction between animated LED patterns and the dichroic film assembly.
